(19) United States
(12) Patent Application Publication
(10) Pub. No.: US 2015/0302129 A1
(43) Pub. Date: Oct. 22, 2015

(54) MASK ASSIGNMENT TECHNIQUE FOR M1 METAL LAYER IN TRIPLE-PATTERNING LITHOGRAPHY

(71) Applicant: QUALCOMM Incorporated, San Diego, CA (US)

(72) Inventors: Xiangdong CHEN, Irvine, CA (US); Mukul GUPTA, San Diego, CA (US); Ohsang KWON, San Diego, CA (US); Foua VANG, San Diego, CA (US)

(73) Assignee: QUALCOMM Incorporated, San Diego, CA (US)

(21) Appl. No.: 14/255,677

(22) Filed: Apr. 17, 2014

(51) Int. Cl. G06F 17/50

(52) U.S. Cl. CPC G06F 17/5072

(57) ABSTRACT

In an embodiment, a method in the manufacture of triple-patterning lithography masks, each mask represented by one of three colors, where each cell layout has exactly one polygonal pattern at one-half the different-color spacing from its left boundary, and exactly one polygonal pattern at one-half the different-color spacing from its right boundary. During placement of the cell layouts into a row, the method includes switching assigned colors in a cell layout to ensure that no two polygonal patterns of the same color in the layout are at a distance from each other less than the same-color spacing.

### FIELD OF DISCLOSURE

Embodiments relate to the design and placement of cell layout for the manufacture of lithography masks.

### BACKGROUND

Multi-patterning techniques in lithography utilize more than one mask in the fabrication of a layer, where an image from each mask is exposed on a resist to define features of the layer. In layout design, multiple colors are used to designate the polygonal features of a mask, where in a multi-patterning layout each color refers to a separate mask. In double-patterning layout techniques, where two colors are employed for two separate masks, design rules include assigning power rails the same color, and maintaining the distance between a polygon and a cell border to be at least one-half the same-color spacing, where the same-color spacing is twice that of the different-color spacing.

For 10 nm process technology where extreme ultraviolet (EUV) lithography is not used, much of the semiconductor industry is moving to triple-patterning lithography in order to further scale pitch size in the M1 layer. The M1 mask layout is relatively difficult to color because it is bi-directional. Accordingly, it is desirable to provide design rules for the M1 metal layer in triple-patterning lithography.

### SUMMARY

Embodiments of the invention are directed to systems and methods for a mask assignment technique for M1 metal layer in triple-patterning lithography.

An embodiment relates to a method in the manufacture of lithography masks. The method comprises assigning a first color, a second color, and a third color to polygonal patterns in a first cell layout, the first cell layout having power rails assigned a same color chosen from the first, second, and third colors; and assigning the first color, the second color, and the third color to polygonal patterns in a second cell layout, the second cell layout having power rails assigned the same color. In the method, the first and second cell layouts each have left and right boundaries, a same-color spacing, and a different-color spacing, wherein for the first and second cell layouts exactly one polygonal pattern is at one-half the different-color spacing from each left boundary and exactly one polygonal pattern is at one-half the different-color spacing from each right boundary, wherein the exactly one polygonal patterns exclude the power rails of the first and second cell layouts.

Another embodiment relates to a non-transitory computer-readable medium having stored instructions that when executed by a processor performs the above-described method.

Another embodiment relates to a method in the manufacture of lithography masks. The method comprises assigning a first color, a second color, and a third color to polygonal patterns in a first cell layout, the first cell layout having power rails assigned a same color chosen from the first, second, and third colors; and assigning the first color, the second color, and the third color to polygonal patterns in a second cell layout, the second cell layout having power rails assigned the same color. In the method, the first and second cell layouts each have left and right boundaries, a same-color spacing, and a different-color spacing, wherein for the first cell layout exactly one polygonal pattern is at a first distance from a first boundary chosen from the left and right boundaries of the first cell layout, and for the second cell layout exactly one polygonal pattern is at a second distance from a second boundary chosen from the left and right boundaries of the second cell layout, wherein the first and second distances are each greater than or equal to the different-color spacing and are each less than one-half the same-color spacing, wherein the exactly one polygonal patterns exclude the power rails of the first and second cell layouts.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a design flow for the manufacture of lithography masks in which embodiments find application.

FIG. 2 illustrates a cell layout for the manufacture of lithography masks according to an embodiment.

FIG. 3 illustrates a design-rule method for the manufacture of lithography masks according to an embodiment.

FIG. 4 illustrates a design-rule method for the manufacture of lithography masks according to an embodiment.

FIG. 5 illustrates a computer system in which an embodiment finds application.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that specific circuits (e.g., application specific integrated circuits (ASICs)), one or more processors executing program instructions, or a combination of both, may perform the various actions described herein. Additionally, the sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

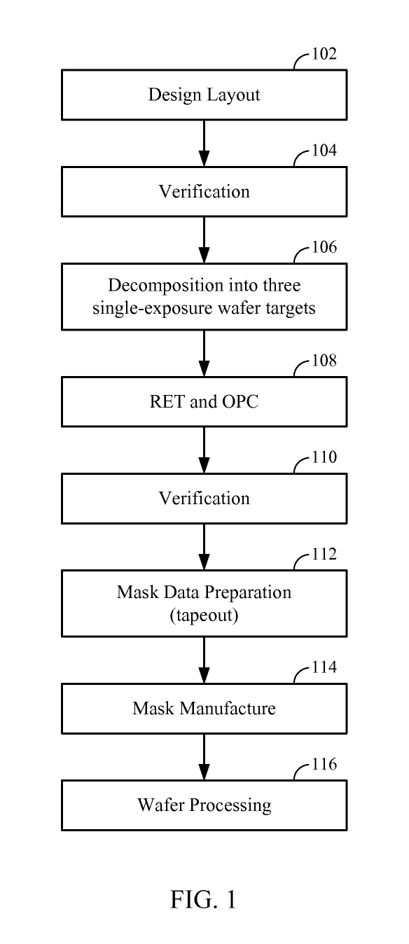

Designing a chip layout, manufacturing masks, and wafer processing together involve many hundreds of steps, but for purposes of describing the disclosed embodiments and placing the embodiments within context, FIG. 1 is referred to where several steps are indicated. The flow diagram of FIG. 1 pertains to triple patterning.

In steps 102 and 104, well-known tools are used in design layout and verification, followed in step 106 by the decomposition of the layout into three single-exposure wafer targets. Well-known RET (Resolution Enhancement Technology), OPC (Optical Proximity Correction), and other computational lithography techniques may be applied in step 108. Verification follows in step 110. In step 112, mask data preparation results in the tapeout files used to manufacture the mask in step 114, where the masks are used in a foundry for wafer processing in step 116. Embodiments pertain to the design layout (step 102), verification (step 104), and decomposition (step 106), where design rules are provided.

In an embodiment, design rules are adhered to with respect to coloring of a cell layout.

Coloring the polygonal patterns of a cell layout refers to assigning the polygonal patterns to a mask. In triple patterning lithography, three colors are used, where each color represents one of three masks. A layout comprises multiple cells placed adjacent to one another, and the design rules according to an embodiment ensure proper mask alignment used in triple-patterning lithography for an M1 layer

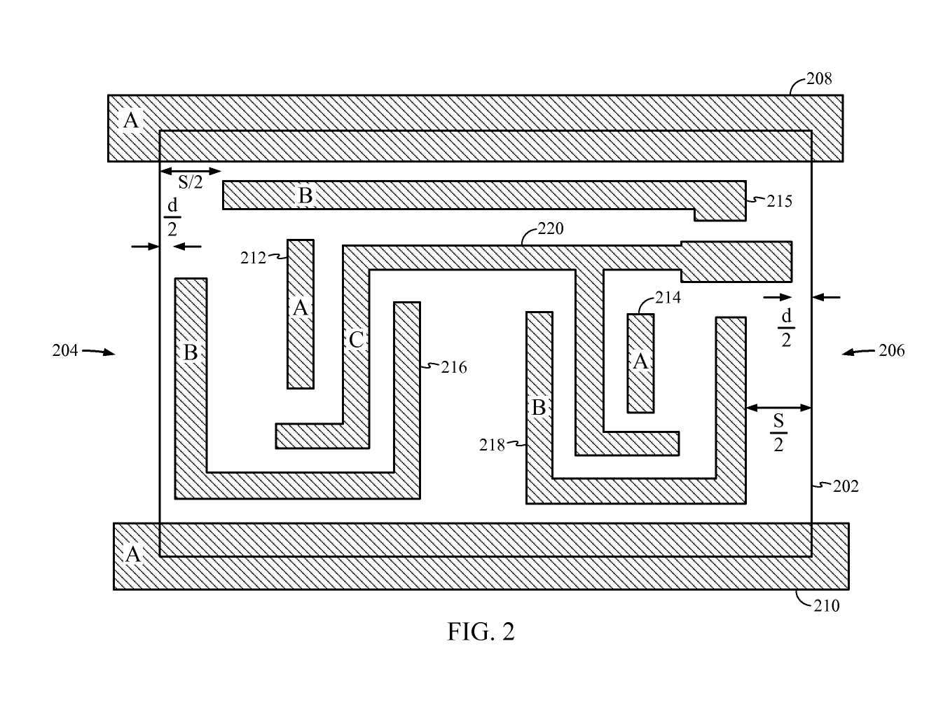

Associated with a cell layout is a boundary, where a left boundary and a right boundary may be identified. For example, referring to the cell layout of FIG. 2, the sold line labeled 202 is the cell boundary, where the arrow labeled 204 points to the left boundary and the arrow labeled 206 points to the right boundary. Accordingly to an embodiment, design rules for a cell layout include assigning the same color to power rails, and allowing at most one polygon pattern per left and right cell boundary to be placed at a distance of one-half the different-color spacing from the cell boundary. Other polygonal patterns may be one-half of the same-color spacing from a cell boundary.

Referring to the cell layout of FIG. 2, the power rails are labeled 208 and 210 and have the same color. The letter A in FIG. 2 is used to designate the color of the power rails 209 and 210, where the letters B and C denote two other colors used to color the various polygonal patterns in FIG. 2. For example, the polygonal patterns 212 and 214 are colored with the color A, the polygonal patterns, 215, 216 and 218 are colored with the color B, and the polygonal region 220 is colored with the color C.

Letting d denote the different-color spacing for the cell layout of FIG. 2, the polygonal pattern 220 is at a distance d/2 from the right boundary 206. Other polygonal patterns may be at one-half the same-color spacing from the right boundary 206. For example, letting s denote the same-color spacing, for the example of FIG. 2 the polygonal pattern 218 is at a distance of s/2 from the right boundary 206. For some embodiments, the same-color spacing may be equal to three times the different-color spacing, so that s=3d. Note that at most only one (exactly one) polygonal pattern is allowed to be at the distance d/2 from the right boundary 206, whereas other polygonal patterns may be no closer than a distance of s/2. Accordingly, an embodiment has exactly one polygonal pattern at the distance d/2 from the right boundary 206

In the example of FIG. 2, the polygonal pattern 216 is at a distance d/2 from the left boundary 204. According to the design rules, at most only one (exactly one) polygonal pattern may be at the distance d/2 from the left boundary 204. For example, the polygonal pattern 215 is at a distance s/2 from the left boundary 204. Note that the polygonal pattern 216 is a different color than the polygonal pattern 220, but this is merely an example and it is not a requirement that the polygonal pattern at a distance of d/2 from the left boundary 204 should be a different color than that of the polygonal pattern at a distance d/2 from the right boundary 206.

For some embodiments, a more general statement of the design rule is that at most only one (exactly one) polygonal pattern may be at a distance x from a left or right cell boundary, where d/2≦x<s/2.

When placing cell layouts next to each other into a row to synthesize a layout, it may happen that two adjacent cells are such that two polygonal patterns of the same color are separated by the different-color spacing d. For example, suppose in a first cell layout a first polygonal pattern of color B is a distance d/2 from its right boundary, and in a second cell layout a second polygonal pattern of the same color B is a distance d/2 from its left boundary. If the second cell layout is placed adjacent and to the right of the first cell layout, then the first polygonal pattern and the second polygonal pattern are separated by the different-color spacing d, leading to an incorrect layout. In such a case, the color scheme in the second cell layout may be changed so that the color B is switched with another color, say the color C. That is, all polygonal patterns in the second cell layout previously colored B are now colored C, and all polygonal patterns in the second cell layout previously colored C are now colored B. In this way, as a row is built up by placing cell layouts adjacent to each other, color may be swapped if necessary to avoid violating a design rule in which polygonal regions of the same color should be separated by at least the same-color spacing s.

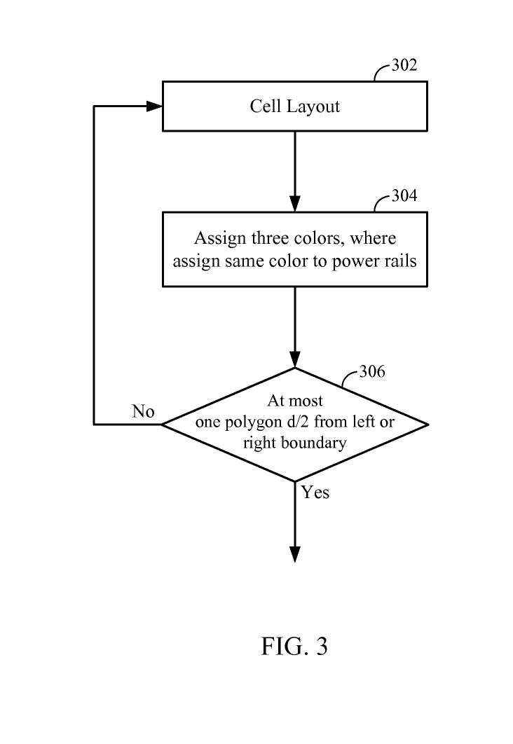

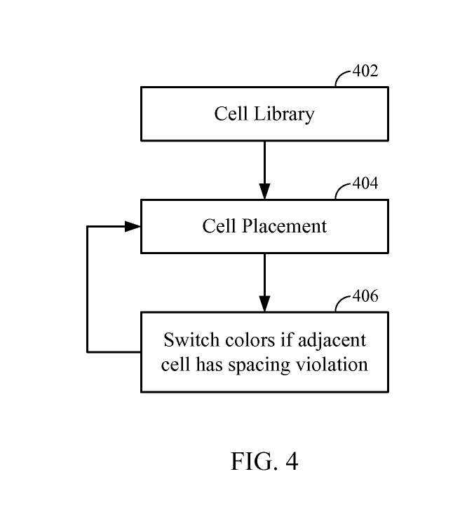

The above embodiments may be illustrated by FIGS. 3 and 4. In FIG. 3, a cell layout tool in the step 302 is used in the design of a cell layout. Such tools are well known in the art, and need not be discussed in detail. An embodiment implements a coloring scheme of assigning up to three colors to polygonal patterns in a cell layout, where the power rails within a cell layout are assigned the same color, as indicated in the step 304. The step 304 may be considered part of the design tool in the step 302. Embodiments implement a design rule, illustrated in the step 306, whereby at most one polygonal pattern may be at one-half the different-color spacing from a left or right boundary. If a prototype cell layout violates this rule, then the cell layout is reconfigured, as indicated by the path from the step 306 to the step 302. The step 306 may be considered part of the design tool illustrated in the step 302, but for simplicity of discussion the step 306 is shown separate from the step 302. If the design rule indicated by the step 306 is met, then further well-known tools are utilized to complete a design layout.

The step 306 may be generalized, as discussed previously, to where at most one polygonal pattern is allowed to be at a distance x from a left or right cell boundary, where d/2≦x<s/2.

In FIG. 4, cells from a cell library 402 are chosen for a design layout, where in the step 404 a tool for cell placement is used. However, if in placing a second cell layout adjacent to a first cell layout there are polygonal patterns of the same color separated by the different-color spacing d, or more generally, separated by a distance x for which x<s, then step 406 indicates that two colors in the second cell layout are switched so that there is no longer a violation of the same-color spacing.

That is, if in placing the second cell layout next to the first cell layout there is a polygonal pattern of color A in the second cell at a distance d (or more generally, a distance x for which x<s) from a polygonal pattern of color A in the first cell layout, then the color scheme for the second cell layout is changed to where colors A and B are substituted. Of course, the polygonal patterns indicated in the step 406 exclude the power rails.

In this way, the design rule for constraining at most one polygonal pattern per cell boundary to lie no closer than one-half the different-color spacing to the left or right cell boundary results in a layout for which polygonal patterns of a first color in a first cell are no closer than the same-color spacing to polygon patterns of the first color in a second cell.

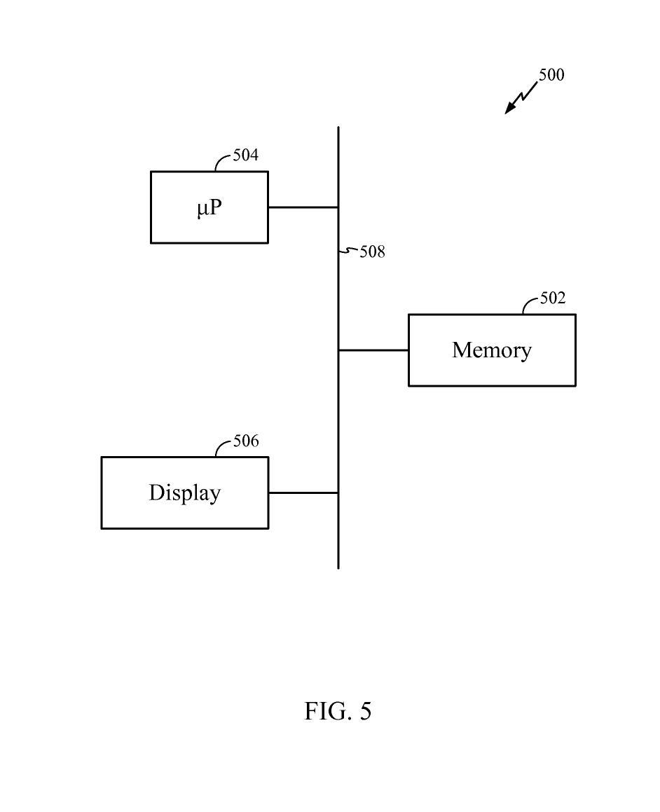

Embodiments pertain to the manufacture of lithography masks, where files for generating the cell layouts and eventually the lithography masks may be data structures stored in a tangible, non-transitory computer-readable medium. For example, in the computer system 500 in FIG. 5, the data structures may be stored in the memory 502, which may be part of a memory hierarchy. The design rules described previously may be implemented as computer-readable instructions stored the memory 502 that when executed on the processor 504 perform the method as illustrated in FIGS. 3 and 4 to provide the cell layout as described with respect to FIG. 2. The cell layout may be visually represented to a user by way of the display 506. The computer system 500 is clearly abstracted in simplified form, where the processor 504, the memory 502, and the display 506 are coupled by way of the system bus 508.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for a mask assignment technique for M1 metal layer in triple-patterning lithography. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method in the manufacture of lithography masks, the method comprising:
assigning a first color, a second color, and a third color to polygonal patterns in a first cell layout, the first cell layout having power rails assigned a same color chosen from the first, second, and third colors; and
assigning the first color, the second color, and the third color to polygonal patterns in a second cell layout, the second cell layout having power rails assigned the same color;
the first and second cell layouts each having left and right boundaries, a same-color spacing, and a different-color spacing, wherein for the first and second cell layouts exactly one polygonal pattern is at one-half the different-color spacing from each left boundary and exactly one polygonal pattern is at one-half the different-color spacing from each right boundary, wherein the exactly one polygonal patterns exclude the power rails of the first and second cell layouts.

2. The method of claim 1, further comprising:
placing the first and second cell layouts into a layout; and
manufacturing a first lithography mask, a second lithography mask, and a third lithography mask based on the first, second, and third colors, respectively.

3. The method of claim 1, further comprising:
placing the second cell layout adjacent to the first cell layout;
assigning the second color to polygonal patterns in the second cell layout previously assigned the first color, and assigning the first color to polygonal patterns in the second cell layout previously assigned the second color, provided a polygonal pattern in the second cell layout previously assigned the first color is the different-color spacing from a polygonal in the first cell layout assigned the first color.

4. The method of claim 3, further comprising:
manufacturing a first lithography mask, a second lithography mask, and a third lithography mask based on the first, second, and third colors, respectively.

5. The method of claim 4, wherein the same-color spacing is three times the different-color spacing.

6. A non-transitory computer-readable medium having stored instructions that when executed by a processor perform a method in the manufacture of lithography masks, the method comprising:
assigning a first color, a second color, and a third color to polygonal patterns in a first cell layout, the first cell layout having power rails assigned a same color chosen from the first, second, and third colors; and
assigning the first color, the second color, and the third color to polygonal patterns in a second cell layout, the second cell layout having power rails assigned the same color;
the first and second cell layouts each having left and right boundaries, a same-color spacing, and a different-color spacing, wherein for the first and second cell layouts exactly one polygonal pattern is at one-half the different-color spacing from each left boundary and exactly one polygonal pattern is at one-half the different-color spacing from each right boundary, wherein the exactly one polygonal patterns exclude the power rails of the first and second cell layouts.

7. The non-transitory computer-readable medium of claim 6, the method further comprising:
placing the first and second cell layouts into a layout; and
manufacturing a first lithography mask, a second lithography mask, and a third lithography mask based on the first, second, and third colors, respectively.

8. The non-transitory computer-readable medium of claim 6, the method further comprising:
placing the second cell layout adjacent to the first cell layout;
assigning the second color to polygonal patterns in the second cell layout previously assigned the first color, and assigning the first color to polygonal patterns in the second cell layout previously assigned the second color, provided a polygonal pattern in the second cell layout previously assigned the first color is the different-color spacing from a polygonal in the first cell layout assigned the first color.

9. The non-transitory computer-readable medium of claim 8, the method further comprising:
manufacturing a first lithography mask, a second lithography mask, and a third lithography mask based on the first, second, and third colors, respectively.

10. The non-transitory computer-readable medium of claim 9, wherein the same-color spacing is three times the different-color spacing.

11. A method in the manufacture of lithography masks, the method comprising:
assigning a first color, a second color, and a third color to polygonal patterns in a first cell layout, the first cell layout having power rails assigned a same color chosen from the first, second, and third colors; and
assigning the first color, the second color, and the third color to polygonal patterns in a second cell layout, the second cell layout having power rails assigned the same color;
the first and second cell layouts each having left and right boundaries, a same-color spacing, and a different-color spacing,
wherein for the first cell layout exactly one polygonal pattern is at a first distance from a first boundary chosen from the left and right boundaries of the first cell layout, and for the second cell layout exactly one polygonal pattern is at a second distance from a second boundary chosen from the left and right boundaries of the second cell layout,
wherein the first and second distances are each greater than or equal to the different-color spacing and are each less than one-half the same-color spacing,
wherein the exactly one polygonal patterns exclude the power rails of the first and second cell layouts.

12. The method of claim 11, further comprising:
placing the first and second cell layouts into a layout; and
manufacturing a first lithography mask, a second lithography mask, and a third lithography mask based on the first, second, and third colors, respectively.

13. The method of claim 11, further comprising:
placing the second cell layout adjacent to the first cell layout;
assigning the second color to polygonal patterns in the second cell layout previously assigned the first color, and assigning the first color to polygonal patterns in the second cell layout previously assigned the second color, provided a polygonal pattern in the second cell layout previously assigned the first color and a polygonal pattern in the first cell layout assigned the first color are at a distance from each other less than the same-color spacing.

14. The method of claim 13, further comprising:
manufacturing a first lithography mask, a second lithography mask, and a third lithography mask based on the first, second, and third colors, respectively.

15. The method of claim 14, wherein the same-color spacing is three times the different-color spacing.
